(19) United States
(12) Patent Application Publication
(10) Pub. No.: US 2008/0256637 A1
(43) Pub. Date: Oct. 16, 2008

(54) Computer System and Security Reinforcing Method Thereof

(75) Inventors: Yongfeng Liu, Beijing (CN); Chunyu Song, Beijing (CN); Ke Ke, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 12/088,603

(22) PCT Filed: Mar. 22, 2006
(86) PCT No.: PCT/CN2006/000461

§ 371 Date: Apr. 9, 2008

(30) Foreign Application Priority Data
Sep. 30, 2005 (CN) 200510112506.2

(51) Int. Cl. G06F 21/00

(52) U.S. Cl. 726/25

(57) ABSTRACT

The present invention provides a computer system for carrying out security reinforcing and a security reinforcing method. The computer system comprises hardware, a BIOS, and a virtual machine monitor, and has at least one servo operating system and at least one user operating system running thereon, wherein, the servo operating system comprises a security reinforcing proxy module, and the user operating system comprises a security reinforcing module. With the present invention, it is possible to prevent the security reinforcing performance from being tampered by the frangibility of the user operating system, and to avoid hacker attacks which cannot be avoided in case of regular or manual security reinforcing, and also to ensure better secure defense of the computer system and the security of the downloaded security reinforcing files own.

### BACKGROUND OF THE INVENTION

1. Field of Invention

The present invention relates to the computer system security field, more particularly, to a computer system security reinforcing method based on virtual machine technologies.

2. Description of Prior Art

People depend on computers more and more, and demands for information security are becoming higher and higher, with increasing development of computer and internet technologies. At the same time, attacking means of hackers vary constantly, and damages caused by various attacking actions (for example, denial of service attacks, viruses, Trojans, and information steeling and the like) are becoming more and more serious.

There are mainly two types of computer security reinforcing technologies now. One type of computer security reinforcing technology is to regularly download latest system patches or virus libraries by running software on an original operating system so as to update and reinforce a computer system. The other type of computer security reinforcing technology is to install anti-virus software in an embedded system, and first enter the embedded system upon system startup, and then start the anti-virus software installed therein so as to search for and kill viruses in a user file system, and thus kill viruses in the whole system.

However, there are following disadvantages for the above described security reinforcing technologies.

1) Since the system reinforcing software runs on the original operating system, the actual effects thereof may be tampered to a large extent by the frangibility of the system own.

2) The system reinforcing is carried out regularly or manually, but the latest virus attacks or actions of destroying and steeling information by the hackers by means of the latest system vulnerabilities are prior to these system reinforcing actions, so in practice the whole system is not effectively protected indeed.

3) In practice, since various pieces of system reinforcing software are separate, they cannot form a tightly integrated system reinforcing solution. For example, auto-downloading of the virus libraries for anti-virus and auto-downloading of the operating system patches cannot be carried out simultaneously. As a result, the above system reinforcing technology has a lowered secure defense for the whole system.

4) Further, since there is no secure system channel for downloading the system patches and the virus libraries and the like, the security of the system reinforcing files own cannot be ensured.

Therefore, it is necessary to provide a more secure and effective security reinforcing technology to overcome the above disadvantages of the existing security reinforcing technologies, so as to ensure the security of the computer systems.

### SUMMARY OF THE INVENTION

It is an object of the present invention to provide a computer system capable of carrying out security reinforcing.

It is another object of the present invention to provide a computer system security reinforcing method.

The computer system according to the present invention comprises hardware, a BIOS, and a virtual machine monitor, and has at least one servo operating system and at least one user operating system running thereon, wherein, the servo operating system comprises a security reinforcing proxy module, and the user operating system comprises a security reinforcing module.

The security reinforcing proxy module carries out communicating by establishing a secure channel with a security server in a network in which a user locates, so as to check whether versions of various security reinforcing files in the local computer system are the latest ones, and to download the latest security reinforcing files from the server in the network and thus carry out corresponding security reinforcing operations according to the types of the downloaded security reinforcing files.

The security reinforcing module is provided for checking the various security reinforcing files, updating the user operating system and various user installed programs and library files on this user operating system according to security reinforcing rules defined by the user or an administrator, and also recording a security reinforcing log. Then, it informs the security reinforcing proxy module of the servo operating system via the virtual machine monitor of the version information of the various security reinforcing files, making the security reinforcing proxy module know the latest version information of the security reinforcing files in the user operating system, and saves the latest version information in the servo operating system.

The security reinforcing method according to the present invention comprises the following steps.

Step 1: The computer system is started or reset, and the BIOS boots the virtual machine monitor.

Step 2: The virtual machine monitor boots the servo operating system, to start the security reinforcing proxy module of the servo operating system.

Step 3: The security reinforcing proxy module establishes the secure channel with the security server in the network in which the user locates, to check whether the versions of the various local security reinforcing files are the latest ones.

i) When the versions of the various local security reinforcing files are the latest ones, there is no need to carry out security reinforcing on the computer system, and thus the secure channel is shut off.

ii) When part or all of the versions of the various local security reinforcing files are not the latest ones, the security reinforcing proxy module downloads the latest security reinforcing files to a storage device of the local computer system via the secure channel from the security server in the network, and then shuts off the secure channel.

Step 4: The security reinforcing proxy module decides the types of the security reinforcing files from the security server, and carries out the corresponding security reinforcing operations according to the types of the security reinforcing files.

Step 5: A virtual hardware environment for the user operating system is established by means of the virtual machine monitor, and the kernel of the user operating system is booted in this virtual environment.

Step 6: After the kernel of the user operating system is started but before all modules and services of the user operating system are loaded, the security reinforcing module is loaded, to check the various security reinforcing files, and then update the user operating system and the various user installed programs and library files on this user operating system according to the security reinforcing rules, and also record the security reinforcing log.

Step 7: After completing the security reinforcing for the user operating system, the security reinforcing module informs the security reinforcing proxy module of the servo operating system via the virtual machine monitor of the latest version information of the various security reinforcing files, and saves the latest version information in the servo operating system.

Step 8: The kernel of the user operating system continues to load other modules and services, and finally starts various applications.

The present invention provides the following advantages.

a) It is possible to prevent the security reinforcing performance from being tampered by the frangibility of the user operating system by downloading the security reinforcing files through the security reinforcing proxy module of the servo operating system;

b) It is possible to avoid hacker attacks, which cannot be avoided in case of regular or manual security reinforcing, by updating the security reinforcing files upon starting or resetting the virtual computer system;

c) It is possible to ensure better secure defense of the computer system by downloading the various latest security reinforcing files at one time from the security server in the network by the security reinforcing proxy module; and

d) It is possible to ensure the security of the downloaded security reinforcing files own by establishing the secure channel between the security reinforcing proxy module and the security server in the network.

### BRIEF DESCRIPTION OF THE DRAWINGS

FIG. 1 is a structural diagram showing a computer system which can embody a security reinforcing method according to the present invention.

FIG. 2 is a schematic diagram showing communication performed by the local computer system via a security reinforcing proxy module of a servo operating system with a security server in a network in which a user locates.

FIG. 3 is a flowchart showing a computer system security reinforcing method according to the present invention.

### DETAILED DESCRIPTION OF PREFERRED EMBODIMENTS

Hereinafter, a computer system security reinforcing method according to the present invention is explained with reference to the drawings.

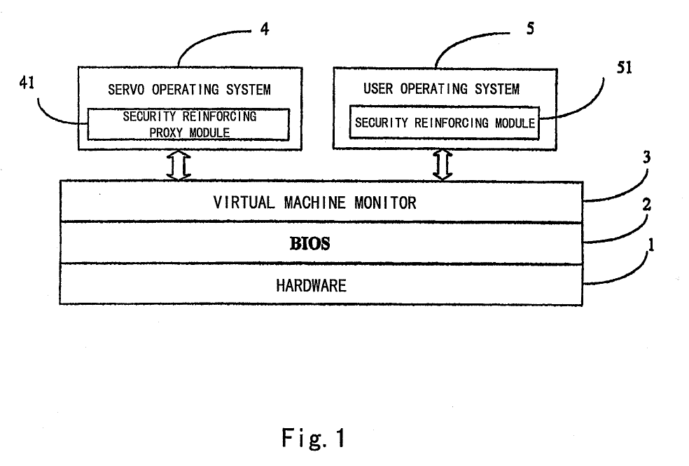

FIG. 1 is a structural diagram showing a computer system which can embody the security reinforcing method according to the present invention. As shown in FIG. 1, the computer system comprises hardware 1, a BIOS 2, and a virtual machine monitor 3, and has at least one servo operating system 4 and at least one user operating system 5 running thereon. The servo operating system 4 may be an embedded operating system, such as an embedded Linux operating system, wherein a security reinforcing proxy module 41 is provided. In the user operating system 5, there is provided a security reinforcing module 51, which is a kernel-level security reinforcing module.

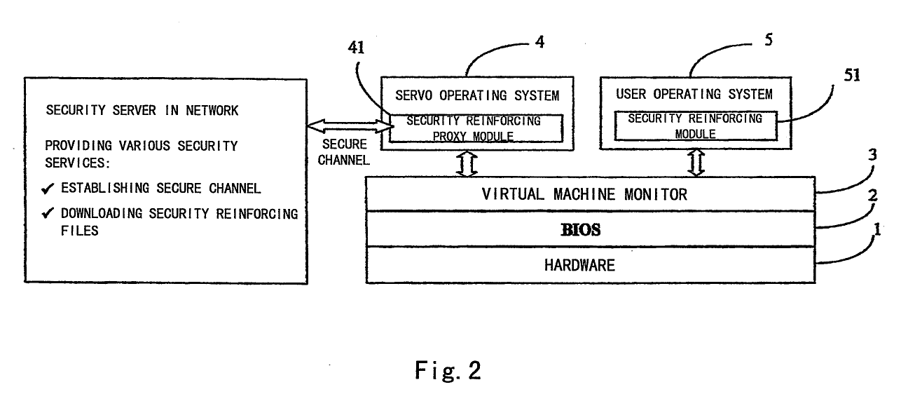

FIG. 2 is a schematic diagram showing communication performed by the local computer system via the security reinforcing proxy module 41 of the servo operating system 4 with a security server in a network in which a user locates.

As shown in FIG. 2, the security reinforcing proxy module 41 may establish a secure channel for communicating with the security server in the network in which the user locates, which server is considered by the computer system as a trusted server. For example, the secure channel may be established by use of PPTP, L2TP, LPSec, and SSL protocols and the like.

Through the secure channel established with the server in the network, the security reinforcing proxy module 41 is capable of checking whether versions of various security reinforcing files in the local compute system are the latest ones. Further, through the secure channel, the security reinforcing proxy module 41 is capable of downloading the latest security reinforcing files from the server in the network, and carrying out corresponding security reinforcing operations according to the types of the downloaded security reinforcing files. The security reinforcing files may comprise the following types: operating system kernels, operating system patches (for example, various run-time libraries, drivers, and system service programs and the like), and user installed program feature libraries and rule libraries thereof (for example, firewalls, anti-virus programs, and IDS and the like).

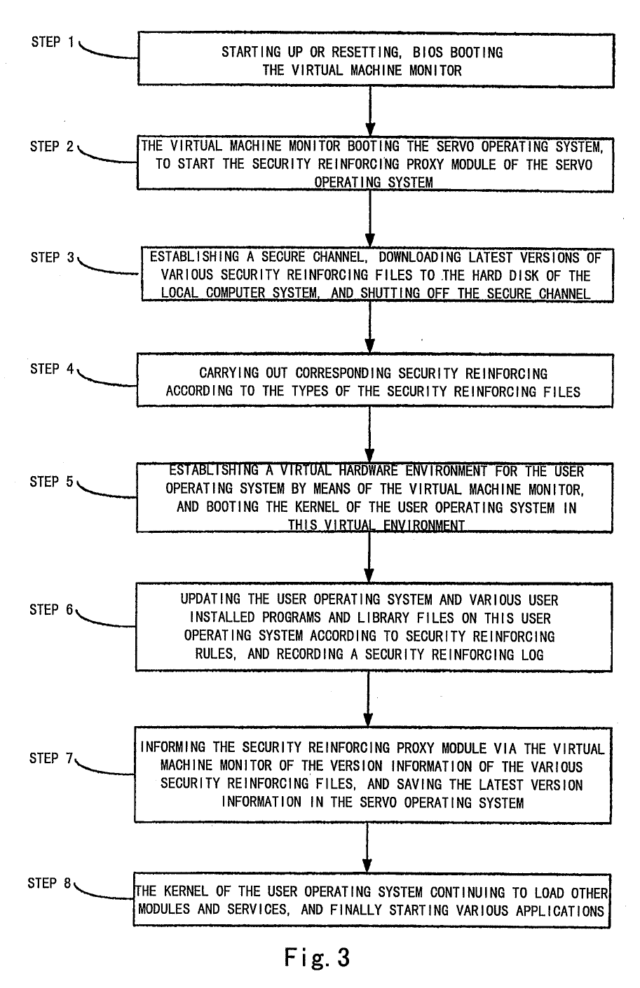

FIG. 3 is a flowchart showing the computer system security reinforcing method according to the present invention. As shown in FIG. 3, the security reinforcing method according to the present invention comprises the following steps.

Step 1: The computer system is started or reset, and the BIOS 2 boots the BOOTLOAD, and the BOOTLOAD boots the virtual machine monitor 3.

Step 2: The virtual machine monitor 3 boots the servo operating system 4, to start the security reinforcing proxy module 41 of the servo operating system 4.

Step 3: The security reinforcing proxy module 41 establishes the secure channel with the security server in the network in which the user locates, to check whether the versions of the various local security reinforcing files are the latest ones.

i) When the versions of the various local security reinforcing files are the latest ones, there is no need to carry out security reinforcing on the computer system, and thus the secure channel is shut off.

ii) When part or all of the versions of the various local security reinforcing files are not the latest ones, the security reinforcing proxy module 41 downloads the latest security reinforcing files to a storage device (for example, a hard disk, a volatile memory such as RAM, an nonvolatile memory such as ROM and flash memory, and a rewritable CD and the like) of the local computer system via the secure channel from the security server in the network, and then shuts off the secure channel. The latest security reinforcing files may be downloaded to specific locations in the storage device.

Step 4: The security reinforcing proxy module 41 decides the types of the security reinforcing files from the security server, and carries out corresponding security reinforcing according to the types of the security reinforcing files. For example, when the security reinforcing file is a latest operating system kernel, the security reinforcing proxy module 41 updates this security reinforcing file to a prescribed location in the storage device, and records a log. When the security reinforcing file is a latest operating system patch or an upgrade packet for user programs (for example, anti-virus scanning engines, virus libraries, and firewall rule libraries and the like), no operation is performed temporarily.

Step 5: A virtual hardware environment for the user operating system 5 is established by means of the virtual machine monitor 3, and the kernel of the user operating system 5 is booted in this virtual environment.

Step 6: After the kernel of the user operating system 5 is started but before all modules and services of the user operating system are loaded, the security reinforcing module 51 is loaded, to check the various security reinforcing files, and then update the user operating system 5 and various user installed programs and library files on this user operating system according to security reinforcing rules defined by the user or an administrator, and also record a security reinforcing log.

Step 7: After completing the security reinforcing for the user operating system 5, the security reinforcing module 51 informs the security reinforcing proxy module 41 of the servo operating system 4 via the virtual machine monitor 3 of the version information of the various security reinforcing files, making the security reinforcing proxy module 41 know the latest version information of the security reinforcing files in the user operating system 5, and saves the latest version information in the servo operating system, so as to help check the versions of the security reinforcing files when the computer system starts again.

Step 8: The kernel of the user operating system 5 continues to load other modules and services, and finally starts various applications.

The computer system security reinforcing method according to the present invention is characterized in that:

a) it is possible to prevent the security reinforcing performance from being tampered by the frangibility of the user operating system 5 by downloading the security reinforcing files through the security reinforcing proxy module 41 of the servo operating system 4;

b) it is possible to avoid hacker attacks, which cannot be avoided in case of regular or manual security reinforcing, by updating the security reinforcing files upon starting or resetting the virtual computer system;

c) it is possible to ensure better secure defense of the computer system by downloading various latest security reinforcing files at one time from the security server in the network by the security reinforcing proxy module 41; and

d) it is possible to ensure the security of the downloaded security reinforcing files own by establishing the secure channel between the security reinforcing proxy module 41 and the security server in the network.

Therefore, after being processed with the security reinforcing method according to the present invention, the user operating system 5 will be the safest one in the network.

For those skilled in the art, it is easy to conceive other embodiments and variations based on the above implementations. Therefore, the present invention is not limited to the above specific embodiments, which are only intended to provide a detail and exemplary illustration for one form of the present invention by way of example. Those skilled in the art may derive similar technical solutions by equivalent replacements based on the above specific embodiments without departing from the spirit of the present invention, which solutions shall fall into the scope of the claims and the equivalent thereof.

1. A computer system for carrying out security reinforcing, comprising hardware, a BIOS, and a virtual machine monitor, characterized in further comprising at least one servo operating system and at least one user operating system running on the computer system, wherein,
the servo operating system is booted before the user operating system is booted;
the servo operating system comprises a security reinforcing proxy unit for communicating with a security server in a network in which the computer system locates, to determine whether it is needed to carry out security reinforcing on the user operating system or not, and to determine whether the security reinforcing on the user operating system is to be carried out by the security reinforcing proxy unit itself or not based on the types of security reinforcing files to be reinforced.

2. The computer system according to claim 1, characterized in that, the security reinforcing files comprise at least one of operating system kernels, operating system patches, and user installed program feature libraries and rule libraries thereof.

3. The computer system according to claim 2, characterized in that, when the type of the security reinforcing file to be reinforced is an operating system kernel, the security reinforcing proxy unit immediately carries out security reinforcing on the user operating system to update the operating system kernel of the user operating system.

4. The computer system according to claim 1, characterized in that, the user operating system comprises a security reinforcing unit for updating the security reinforcing files in the user operating system when the security reinforcing proxy unit determines it is needed to carry out security reinforcing on the user operating system while the security reinforcing on the user operating system is not to be carried out by the security reinforcing proxy unit itself.

5. The computer system according to claim 4, characterized in that, the security reinforcing unit checks the security reinforcing files in the user operating system, and provides the version information thereof to the security reinforcing proxy unit via the virtual machine monitor.

6. The computer system according to claim 1, characterized in that, the security reinforcing proxy unit determines whether it is needed to carry out security reinforcing on the user operating system or not by comparing at least one of the versions of the various security reinforcing files in the user operating system and check sums thereof with at least one of the versions of the files in the security server and check sums thereof.

7. The computer system according to claim 6, characterized in that, if it is needed to carry out security reinforcing on the user operating system, the security reinforcing proxy unit downloads the latest security reinforcing files from the security server.

8. The computer system according to claim 1, characterized in that, the servo operating system is an embedded operating system.

9. The computer system according to claim 1, characterized in the security reinforcing proxy unit communicates with the security server by means of PPTP, L2TP, IPSec or SSL protocol.

10. A computer system security reinforcing method, comprising steps of:
booting at least one servo operating system before booting a user operating system;
communicating with a security server in a network in which the computer system locates by a security reinforcing proxy unit of the servo operating system, to determine whether it is needed to carry out security reinforcing on the user operating system or not;
determining whether the security reinforcing on the user operating system is to be carried out by the security reinforcing proxy unit itself or not based on the types of security reinforcing files to be reinforced; and
immediately carrying out security reinforcing on the user operating system and updating the corresponding security reinforcing files in the user operating system when it is determined that the security reinforcing on the user operating system is to be carried out by the security reinforcing proxy unit itself.

11. The computer system security reinforcing method according to claim 10, characterized in that, the security reinforcing files comprise at least one of operating system kernels, operating system patches, and user installed program feature libraries and rule libraries thereof.

12. The computer system security reinforcing method according to claim 11, characterized in that, when the type of the security reinforcing file to be reinforced is an operating system kernel, it is determined that the security reinforcing on the user operating system is to be carried out by the security reinforcing proxy unit itself.

13. The computer system security reinforcing method according to claim 1, further comprising a step of:
updating the security reinforcing files in the user operating system by a security reinforcing unit of the user operating system when the security reinforcing proxy unit determines it is needed to carry out security reinforcing on the user operating system while the security reinforcing on the user operating system is not to be carried out by the security reinforcing proxy unit itself.

14. The computer system security reinforcing method according to claim 13, further comprising a step of:
checking the security reinforcing files in the user operating system by the security reinforcing unit, and providing the version information thereof to the security reinforcing proxy unit via a virtual machine monitor.

15. The computer system security reinforcing method according to claim 1, characterized in that, the security reinforcing proxy unit determines whether it is needed to carry out security reinforcing on the user operating system or not by comparing at least one of the versions of the various security reinforcing files in the user operating system and check sums thereof with at least one of the versions of the files in the security server and check sums thereof.

16. The computer system security reinforcing method according to claim 15, further comprising a step of:
downloading the latest security reinforcing files from the security server by the security reinforcing proxy unit if it is needed to carry out security reinforcing on the user operating system.

17. The computer system security reinforcing method according to claim 10, characterized in that, the servo operating system is an embedded operating system.

18. The computer system security reinforcing method according to claim 10, characterized in that, the security reinforcing proxy unit communicates with the security server by means of PPTP, L2TP, IPSec or SSL protocol.
